(19) United States
(12) Patent Application Publication
(10) Pub. No.: US 2005/0243664 A1
(43) Pub. Date: Nov. 3, 2005

(54) Method and device for long-range track seeking control in an optical storage system

(75) Inventors: Hsu-Feng Ho, Taipei City (TW); Kun-Hung Hsieh, Hsin-Chu City (TW)

Correspondence Address: LADAS & PARRY, 26 West 61st. Street, New York, NY, 10023-7604, US

(73) Assignee: MEDIATEK INC.

(21) Appl. No.: 10/886,287

(22) Filed: Jul. 7, 2004

(30) Foreign Application Priority Data
Apr. 30, 2004 (TW) 93112142

(51) Int. Cl. G11B 7/00

(52) U.S. Cl. 369/44.25

(57) ABSTRACT

A device for long-range track seeking control in an optical storage system includes a controller that calculates a track displacement count based on initial and target track positions of an optical pickup, a calculator that calculates a motor actuation count based on the track displacement count and an initial track crossing parameter, a control signal generator that generates a control signal in accordance with the motor actuation count, a driver that actuates the sled motor so as to move the optical pickup in response to the control signal, and a heuristic calibrating unit that is operable so as to revise the initial track crossing parameter in accordance with a residual track count calculated from the target track position and a current track position resulting from movement of the optical pickup.

### CROSS-REFERENCE TO RELATED APPLICATION

This application claims priority of Taiwanese application no. 093112142, filed on Apr. 30, 2004.

### BACKGROUND OF THE INVENTION

1. Field of the Invention

The invention relates to an optical storage system, more particularly to a method and device for long-range track seeking control in an optical storage system.

2. Description of the Related Art

Referring to FIG. 1, in a conventional optical storage system, a laser beam 10 is generated for reading data recorded in tracks of an optical disc 12 that is rotated by a spindle motor 11. When reading a target track position of the optical disc 12, a sled 13 is employed for long-range track seeking, whereas a fine actuator 14 is employed for short-range track seeking. Particularly, during long-range track seeking, a sled motor 131 of the sled 13 is activated to move an optical pickup 15 to a vicinity of the target track position. Thereafter, the fine actuator 14, such as a voice coil motor that is disposed on the sled 13, is activated so as to accurately position the laser beam 10 on the target track position. Since long-range track seeking generally takes up a lot of time, it is considered to be a key factor that affects data access speed in optical storage systems.

Optical storage systems generate track-crossing signals, such as tracking error signals (TE) and radio-frequency ripple signals (RFRP), during track-crossing activity of the optical pickup 15. However, in case of long-range track seeking, since the moving speed of the sled 13 is relatively fast, the number of track crossings counted from the track-crossing signals is unreliable in view of bandwidth and signal quality considerations. Hence, manufacturers normally employ other means for measuring radial track displacement in lieu of the track-crossing signals.

In theory, the sled motor 131 is associated with a track crossing parameter that defines the number of tracks of the optical disc 12 crossed by the optical pickup 15 during an actuation cycle (such as one step of a stepping motor) of the sled motor 131. The track crossing parameter is equal to the quotient of the radial track displacement for a single actuation cycle of the sled motor 131 and the distance between tracks of the optical disc 12. When moving the optical pickup 15 from an initial track position to a target track position of the optical disc 12, a track displacement count equal to the difference between the initial and target track positions is first calculated, and a motor actuation count is subsequently calculated by dividing the track displacement count by the track crossing parameter of the sled motor 131. The motor actuation count defines the number of actuation cycles required by the sled motor 131 to move the optical pickup 15 from the initial track position to the target track position, and is dependent upon the track crossing parameter of the sled motor 131.

Currently, there are two known configurations that utilize the aforesaid control scheme. In the first configuration, the sled motor 131 is implemented using a stepping motor, and an open-loop method is employed for track-crossing control based on the required track displacement. In the second configuration, the sled motor 131 is implemented using a direct current motor, and a counter, such as a photo interrupt counter or a position control system (PCS), is used to measure angular rotation of the direct current motor, thereby dispensing with the need to measure radial track crossings using inaccurate and unreliable track-crossing signals. The aforementioned two known configurations involve conversion of the track displacement count into a motor actuation count, which is a step count in the case of a stepping motor and a photo interrupt count in the case of a direct current motor, when moving the optical pickup to the vicinity of the target track position of the optical disc.

In current applications, the track crossing parameter of the sled motor 131 is set to a constant theoretical value. However, there are many factors, such as a very small track width (for instance, 0.74 μm for a DVD track width, and 1.6 μm for a CD track width), gear backlash of the sled mechanism, manufacturing tolerances, etc., that can affect the actual value of the track crossing parameter. Therefore, when a constant theoretical track crossing parameter is used for motor control, there is a likelihood of a large error between actual and predicted track displacement, thereby necessitating several track-crossing operations before the target track position is reached.

### SUMMARY OF THE INVENTION

Therefore, the object of the present invention is to provide a method and device for long-range track seeking control in an optical storage system that can overcome the aforesaid drawbacks associated with the prior art.

According to one aspect of the present invention, there is provided a method for long-range track seeking control in an optical storage system that is loaded with an optical disc and that includes an optical pickup and a sled motor for moving the optical pickup from an initial track position of the optical disc to a target track position of the optical disc. The method comprises the steps of:
a) calculating a track displacement count based on the initial and target track positions;
b) calculating a motor actuation count based on the track displacement count and an initial track crossing parameter associated with the sled motor, the track crossing parameter defining a number of tracks of the optical disc crossed during an actuation cycle of the sled motor;
c) actuating the sled motor according to the motor actuation count so as to move the optical pickup;
d) after moving the optical pickup, calculating a residual track count based on a current track position and the target track position of the optical disc; and
e) revising the initial track crossing parameter in accordance with the residual track count.

According to another aspect of the present invention, there is provided a device for long-range track seeking control in an optical storage system that is loaded with an optical disc and that includes an optical pickup and a sled motor for moving the optical pickup from an initial track position of the optical disc to a target track position of the optical disc. The device comprises a controller, a calculator, a control signal generator, a driver, and a heuristic calibrating unit.

The controller is adapted to be coupled to the optical storage system so as to receive the initial and target track positions therefrom, and is operable so as to calculate a track displacement count based on the initial and target track positions.

The calculator is coupled to the controller, and is operable so as to calculate a motor actuation count based on the track displacement count and an initial track crossing parameter associated with the sled motor, wherein the track crossing parameter defines a number of tracks of the optical disc crossed during an actuation cycle of the sled motor.

The control signal generator is coupled to the calculator, and is operable so as to generate a control signal in accordance with the motor actuation count.

The driver is coupled to the control signal generator, and is adapted to actuate the sled motor so as to move the optical pickup in response to the control signal from the control signal generator.

The heuristic calibrating unit is coupled to the calculator, and is operable so as to revise the initial track crossing parameter in accordance with a residual track count calculated from the target track position and a current track position resulting from movement of the optical pickup.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of a conventional optical storage system to illustrate components relevant to a track seeking operation;

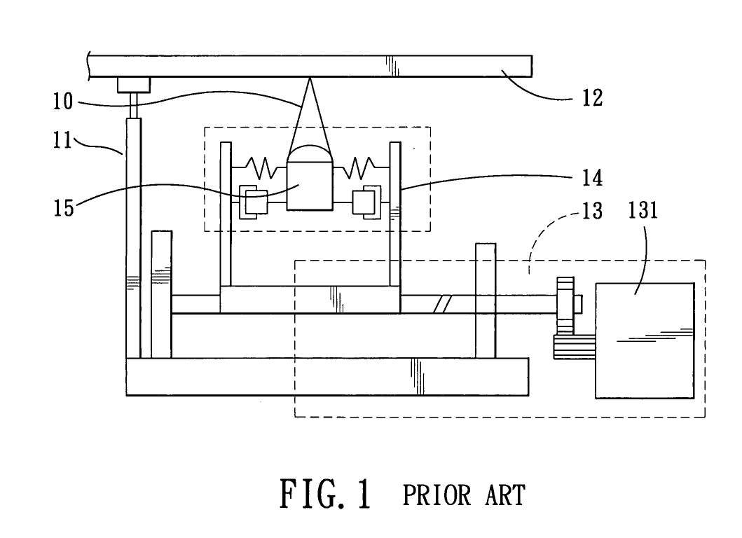

FIG. 2 is a schematic block diagram of the preferred embodiment of a device for long-range track seeking control in an optical storage system according to the present invention; and

FIG. 3 is a flowchart to illustrate steps of the preferred embodiment of a method for long-range track seeking control in an optical storage system according to the present invention.

### DETAILED DESCRIPTION OF THE PREFERRED EMBODIMENT

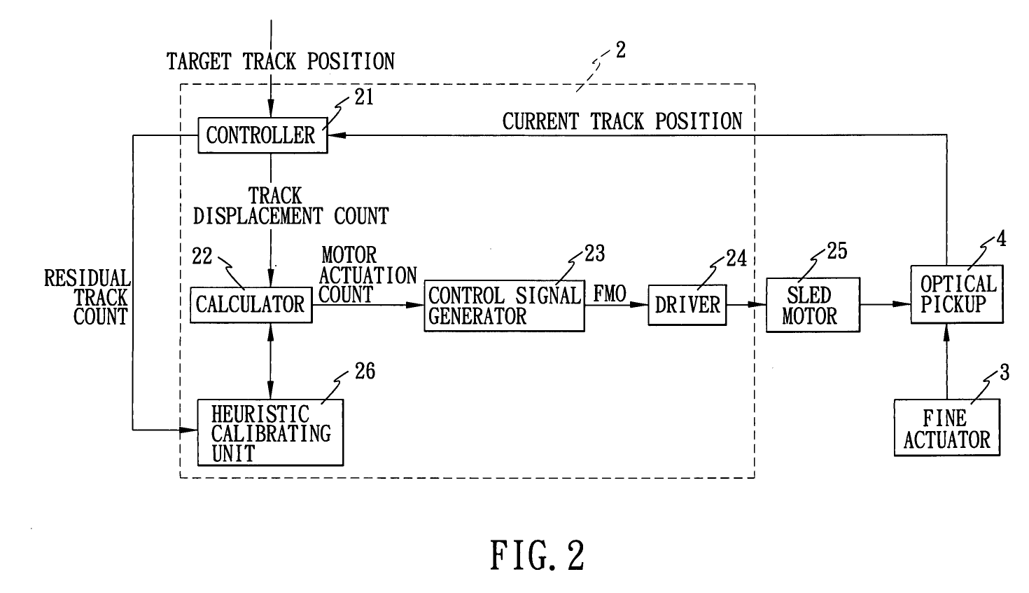

FIG. 2 illustrates the preferred embodiment of a device 2 for long-range track seeking control in an optical storage system according to the present invention. The optical storage system is loaded with an optical disc (not shown), and includes an optical pickup 4 and a sled motor 25 for moving the optical pickup 4 from an initial track position of the optical disc to a target track position of the optical disc. The device 2 comprises a controller 21, a calculator 22, a control signal generator 23, a driver 24, and a heuristic calibrating unit 26.

The controller 21 is adapted to be coupled to the optical storage system. When a long-range track seeking operation is intended, the controller 21 will receive a target track position from the optical storage system, and an initial track position from the optical pickup 4. The controller 21 then calculates a track displacement count, which is a difference between the initial and target track positions.

The calculator 22 is coupled to the controller 21, and is operable so as to calculate a motor actuation count by dividing the track displacement count by an initial track crossing parameter associated with the sled motor 25. The track crossing parameter defines a number of tracks of the optical disc crossed during an actuation cycle of the sled motor 25.

In practice, different track crossing distances (i.e., different magnitudes of the track displacement count) will be affected by ambient factors to varying extent. For instance, when a track crossing distance is shorter, an error attributed to gear backlash will become larger. Therefore, in this embodiment, the initial track crossing parameter is dependent upon the magnitude of the track displacement count. For instance, in the case of a DVD with a total track count of 40000, a first track displacement range is set as more than 20000, a second track displacement range is set as between 5000 and 20000, a third track displacement range is set as between 2000 and 5000, and a fourth track displacement range is set as between 500 and 2000. Each of the first to fourth track displacement ranges has a corresponding initial track crossing parameter. Since the calculator 22 calculates the motor actuation count with reference to the initial track crossing parameter, which varies with the magnitude of the track displacement count, the number of motor actuation cycles needed to move the optical pickup 4 to the vicinity of the target track position can be reduced.

The control signal generator 23 is coupled to the calculator 22, and is operable so as to generate a sled motor control signal (FMO) in accordance with the motor actuation count and with reference to a sled speed configuration file in the control signal generator 23.

The driver 24 is coupled to the control signal generator 23, and actuates the sled motor 25 so as to move the optical pickup 4 in response to the control signal (FMO) from the control signal generator 23.

Since the control signal generator 23 and the driver 24 are well known to those skilled in the art and are not pertinent to the claimed invention, they will not be described in further detail for the sake of brevity.

In this embodiment, after an actuation cycle of the sled motor 131, the controller 21 is further operable so as to calculate a residual track count, which is the difference between the target track position and a current track position resulting from movement of the optical pickup 4. Based on the residual track count, the controller 21 is able to determine whether it is intended to continue with the long-range track seeking operation, or to begin the short-range track seeking operation with the use of a fine actuator 3 so as to correctly position a laser beam on the target track of the optical disc.

The heuristic calibrating unit 26 is coupled to the calculator 22, and is operable so as to revise the initial track crossing parameter in accordance with the residual track count from the controller 21. It should be noted herein that the residual track count is an indication that the optical pickup 4 has yet to be properly positioned during the long-range track seeking operation. In this embodiment, the residual track count is provided by the controller 21 to the heuristic calibrating unit 26 only when the residual track count does not fall within a tolerable range, which is set in this embodiment to be ±50% of the track crossing parameter. The long-range track seeking operation is deemed to be successful when the residual track count falls within the tolerable range. Hence, in this embodiment, the heuristic calibrating unit 26 is configured to revise the initial track crossing parameter only when the residual track count does not fall within the tolerable range. The controller 21 further provides a track jumping status to the heuristic calibrating unit 26. The track jumping status indicates whether over-jumping (i.e., an actual track displacement from the initial track position to the current track position is greater than the predicted track displacement) or under-jumping (i.e., the actual track displacement is less than the predicted track displacement) has occurred.

As mentioned hereinabove, the actual track crossing parameter is affected by numerous ambient factors, such as gear backlash, very small track width, manufacturing tolerance, etc. The presence of the residual track unit verifies that the actual track crossing parameter is not the same as the initial track crossing parameter. In this embodiment, upon receipt of the residual track count from the controller 21, the heuristic calibrating unit 26 increases the initial track crossing parameter with reference to the residual track count when an actual track displacement from the initial track position to the current track position is larger than a predicted track displacement, and decreases the initial track crossing parameter with reference to the residual track count when the actual track displacement is smaller than the predicted track displacement. For instance, if the track displacement count is 1000 tracks, the initial track crossing parameter is 250, under-jumping has occurred, and the residual track count is 200, the heuristic calibrating unit 26 will decrease the track crossing parameter from 250 to 200. On the other hand, if the track displacement count is 1000 tracks, the initial track crossing parameter is 250, over-jumping has occurred, and the residual track count is 200, the heuristic calibrating unit 26 will increase the track crossing parameter from 250 to 300.

In this embodiment, when it is intended to revise an initial track crossing parameter, the heuristic calibrating unit 26 will first determine the current track displacement range before revising the corresponding initial track crossing parameter. After repeated revisions of the initial track crossing parameter for each track displacement range, the initial track crossing parameter will eventually approximate an actual value for the track displacement range. As a result, the number of motor actuation cycles can be reduced to result in a shorter long-range track seeking operation.

While this embodiment is exemplified as one in which the heuristic calibrating unit 26 obtains the residual track count from the controller 21, it is apparent to those skilled in the art that the residual track count may be calculated directly by the heuristic calibrating unit 26 using information from the optical pickup 4.

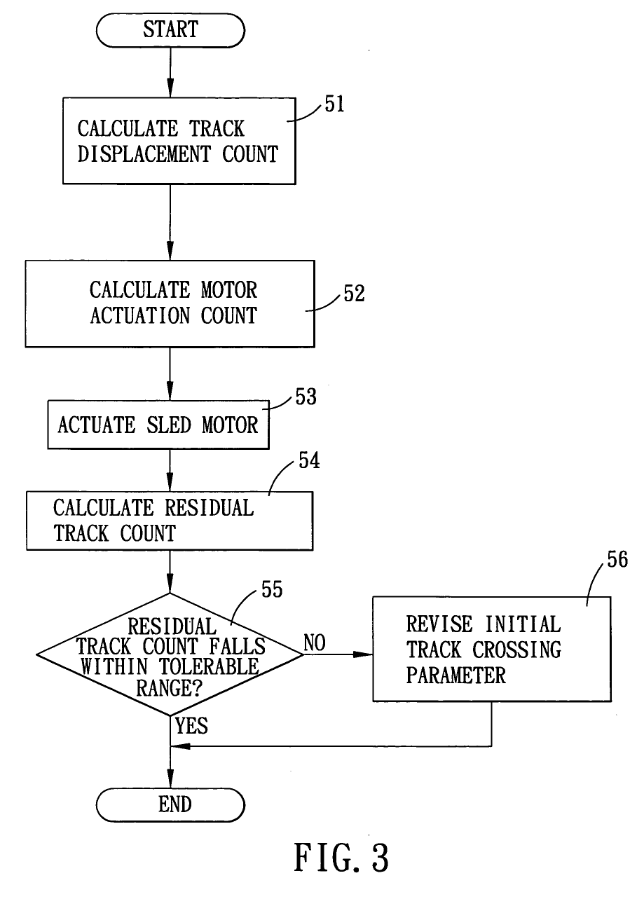

FIG. 3 is a flowchart to illustrate how the device 2 of the preferred embodiment performs long-range track seeking control for moving the optical pickup 4 from the initial track position to the target track position of the optical disc.

In step 51, the controller 21 calculates a track displacement count based on the initial track position from the optical pickup 4 and the target track position from the optical storage system.

In step 52, the calculator 22 receives the track displacement count from the controller 21, determines the track displacement range for the track displacement count, and calculates a motor actuation count based on the track displacement count and the initial track crossing parameter associated with the track displacement range.

In step 53, the control signal generator 23 receives the motor actuation count from the calculator 22, and generates a sled motor control signal (FMO) that is provided to the driver 24. In response to the control signal (FMO), the driver 24 actuates the sled motor 25 to move the optical pickup 4.

Then, in step 54, after moving the optical pickup 4, the controller 21 calculates the residual track count based on a current track position from the optical pickup 4 and the target track position of the optical disc.

Next, in step 55, the controller 21 determines whether the residual track count falls within a tolerable range. In the affirmative, the long-range track seeking operation is deemed to be successful, and the flow ends. Otherwise, the flow goes to step 56.

In step 56, the heuristic calibrating unit 26 receives the residual track count from the controller 21, determines the track displacement range for the track displacement count, and revises the initial track crossing parameter corresponding to the track displacement range with reference to the residual track count in the manner described hereinabove.

It has thus been shown that, in the method and device of this invention, revised initial track crossing parameters are used in the calculation of the motor actuation count for subsequent long-range track seeking operations. As a result, the initial track crossing parameters eventually approximate the actual track crossing parameters, thereby permitting a reduction in the number of motor actuation cycles to result in a shorter long-range track seeking operation.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method for long-range track seeking control in an optical storage system that is loaded with an optical disc and that includes an optical pickup and a sled motor for moving the optical pickup from an initial track position of the optical disc to a target track position of the optical disc, said method comprising the steps of:
a) calculating a track displacement count based on the initial and target track positions;
b) calculating a motor actuation count based on the track displacement count and an initial track crossing parameter associated with the sled motor, the track crossing parameter defining a number of tracks of the optical disc crossed during an actuation cycle of the sled motor;
c) actuating the sled motor according to the motor actuation count so as to move the optical pickup;
d) after moving the optical pickup, calculating a residual track count based on a current track position and the target track position of the optical disc; and
e) revising the initial track crossing parameter in accordance with the residual track count.

2. The method as claimed in claim 1, wherein, in step e), the initial track crossing parameter is revised only when the residual track count does not fall within a tolerable range.

3. The method as claimed in claim 1, wherein the initial track crossing parameter is dependent upon magnitude of the track displacement count.

4. The method as claimed in claim 1, wherein, in step e), the initial track crossing parameter is increased with reference to the residual track count when an actual track displacement from the initial track position to the current track position is larger than a predicted track displacement, and is decreased with reference to the residual track count when the actual track displacement is smaller than the predicted track displacement.

5. A device for long-range track seeking control in an optical storage system that is loaded with an optical disc and that includes an optical pickup and a sled motor for moving the optical pickup from an initial track position of the optical disc to a target track position of the optical disc, said device comprising:
a controller adapted to be coupled to the optical storage system so as to receive the initial and target track positions there from and operable so as to calculate a track displacement count based on the initial and target track positions;
a calculator coupled to said controller and operable so as to calculate a motor actuation count based on the track displacement count and an initial track crossing parameter associated with the sled motor, the track crossing parameter defining a number of tracks of the optical disc crossed during an actuation cycle of the sled motor;
a control signal generator coupled to said calculator and operable so as to generate a control signal in accordance with the motor actuation count;
a driver coupled to said control signal generator and adapted to actuate the sled motor so as to move the optical pickup in response to the control signal from said control signal generator; and
a heuristic calibrating unit coupled to said calculator and operable so as to revise the initial track crossing parameter in accordance with a residual track count calculated from the target track position and a current track position resulting from movement of the optical pickup.

6. The device as claimed in claim 5, wherein said heuristic calibrating unit is configured to revise the initial track crossing parameter only when the residual track count does not fall within a tolerable range.

7. The device as claimed in claim 5, wherein the initial track crossing parameter is dependent upon magnitude of the track displacement count.

8. The device as claimed in claim 5, wherein said heuristic calibrating unit increases the initial track crossing parameter with reference to the residual track count when an actual track displacement from the initial track position to the current track position is larger than a predicted track displacement, and decreases the initial track crossing parameter with reference to the residual track count when the actual track displacement is smaller than the predicted track displacement.

9. The device as claimed in claim 5, wherein said controller is further operable so as to calculate and provide the residual track count to said heuristic calibrating unit.
